(19) United States
(12) Patent Application Publication
(10) Pub. No.: US 2024/0206465 A1
(43) Pub. Date: Jun. 27, 2024

(54) ACTIVE POLYMERIC FILMS AND POLYMERIC COMPOSITIONS

(71) Applicants: Yissum Research Development Company of the Hebrew University of Jerusalem Ltd., Jerusalem (IL); CARMEL OLEFINS LTD., Haifa (IL)

(72) Inventors: Meital RECHES, Kfar Bin Nun (IL); Michael GISHBOLINER, Karmiel (IL); Koranit SHLOSMAN BALASHA, Haifa (IL); Rotem SHEMESH, Haifa (IL)

(73) Assignees: Yissum Research Development Company of the Hebrew University of Jerusalem Ltd., Jerusalem (IL); CARMEL OLEFINS LTD., Haifa (IL)

(21) Appl. No.: 18/555,747

(22) PCT Filed: Apr. 17, 2022
(86) PCT No.: PCT/IL2022/050401

§ 371 Date: Oct. 17, 2023

Related U.S. Application Data
(60) Provisional application No. 63/177,422, filed on Apr. 21, 2021.

(51) Int. Cl. A01N 37/44; A01N 25/10; A01N 25/34; A01P 1/00; A01P 3/00

(52) U.S. Cl. CPC A01N 37/44; A01N 25/10; A01N 25/34; A01P 1/00; A01P 3/00

(57) ABSTRACT

A solid polymer composition or object or composite is provided, which includes a polymeric material and at least one agent having an antimicrobial functionality.

### TECHNOLOGICAL FIELD

The invention generally relates to polymer compositions and articles of manufacture made therefrom.

### BACKGROUND OF THE INVENTION

The intensified spread of infectious diseases caused by bacteria, viruses, and fungi poses a continuous threat to animals, plants and human health. Surfaces made of synthetic polymers easily attract pathogenic microorganisms and play an essential role in infection transmission. Numerous strategies have thus far been used to acquire polymers with antimicrobial properties. These include melt compounding followed by compression, injection and extrusion molding, direct polymerization of antibacterial units and copolymerization of monomers with antibacterial compounds. These approaches can involve polymers formed by organometallic coordination catalysts, comprising metal ions and ligands, free-radical polymerization, and other chemical and physical modifications of polymers. Among these methods, melt compounding and molding procedures are commonly used production methods due to their simplicity, low cost, uniform dispersion of active materials, and eco-friendliness due to solvent-free production.

Various active substances have been incorporated into polymers using this melt compounding and molding techniques. These include natural essential oils, N-halamines, metal oxide nanoparticles, graphene and its derivatives, and antibiotics. Essential oils such as thymol and carvacrol in polypropylene films have demonstrated antimicrobial activity against several bacterial strains including Escherichia coli (E. coli) and Staphylococcus aureus (S. aureus). In addition, when the antimicrobial compound N-halamine was incorporated in a polyurethane film, it exhibited antibacterial activity against E. coli and S. aureus. When applied on a polyethylene surface using a layer-by-layer deposition method, it was found effective against Listeria monocytogenes.

Polyurea and polyguanidine incorporating N-halamine significantly inhibited T4 bacteriophage and plant virus associated with the Tobamovirus genus.

Another group of materials incorporated into polymers includes metal and metal oxides such as silver titanium oxide and zinc oxide. However, these materials are toxic and may thus affect human health. Additional materials used to modify polymers are graphene and graphene oxides. These exhibited antimicrobial activity against Salmonella Typhi and Listeria. Although graphene's derivatives have remarkable physicochemical and antimicrobial properties, it is still unclear whether it is toxic to the environment.

Alternatively, peptides may be used as they are relatively easy to synthesize, non-toxic, and biodegradable. Out of the wide range of antimicrobial peptides, only the peptide nisin, was incorporated into polymer films through solvent casting followed by evaporation or extrusion process. These films exhibited a high reduction of several bacterial strains. However, one of the main challenges when using nisin in polymer films was its release from the polymer. When nisin was incorporated into LDPE, it was rapidly released from the polymer due to absence of chemical bonds with the polymer films matrix. Moreover, the antimicrobial activity of nisin was affected by storage conditions and the preparation process of the films.

U.S. Pat. No. 9,631,100 [1] discloses a series of peptides capable of self-assembly as a film on the surface, adsorb onto the surface and prevent biofouling. Such peptides are reportedly not limited to a specific substrate and can be applied on metals, oxides and polymer surfaces.

US Patent Application No. 2019/201,349 [2] discloses improved material particles based on peptides, formed by self-assembly upon interaction or contact of the materials with water. The particles have been found to be highly effective antifouling materials.

Attachment of peptides to polymer surface, especially to non-polar polymers, like polyolefins, is challenging. A significant difference in polarity of polymer surface and peptide molecules impairs adsorption of the peptides on the surface and facilitates their removal, resulting in restricted antifouling activity, especially in articles designated for long-term and/or repeated use. Chemical bonding of proteins to the surface may improve their retention on the surface. However, such bonding requires chemical modification of the surface, which may be expensive and impede productivity in mass production.

Rübsam et al., [3] teach surface functionalization of biologically inert polymers (e.g., polypropylene, polystyrene and others) with material binding peptides facilitates an efficient immobilization of enzymes, bioactive peptides or antigens at ambient temperature in water. Particularly, surface modification of polypropylene is required for its application as textile fibers, packaging material or filtration membranes. Bonded to the so modified surface protein reportedly withstands washing with surfactant.

A new nano-fibrous substrate-polypropylene grafted with L-Cys with an increased crystallinity was reported [4], providing the surface with —SH hooks necessary to efficiently cross-link the antimicrobial peptide Cys-LC-LL-37 in order to protect against nosocomial pathogens and their spread to community. Surfaces of polypropylene (PP) fabrics modified through thermally initiated radical graft polymerization with acrylic acid and poly (ethylene glycol) di-acrylate were disclosed [5]. Such modification allowed surface functionalities that are beneficial for peptide synthesis and cell specific binding. Instead of or in addition to surface modification, forced deposition of the peptide on the surface using, for example, ultrasonically assisted deposition or UV irradiation, may be applied. These techniques require additional operations, which can adversely affect the mass production efficiency, not to mention that covalent bonding and ultrasonic treatment may impede self-assembly of the peptide on the surface.

### BACKGROUND PUBLICATIONS

[1] U.S. Pat. No. 9,631,100;
[2] US Patent Application No. 2019/201,349;
[3] Kristin Rubsam, Lina Weber, Felix Jakob and Ulrich Schwaneberg, Biotechnology and Bioengineering, vol. 115, issue 2 (2018), pp. 321-330;
[4] Frederico Nogueira, Pilar Teixeira & Isabel C. Gouveia, Journal of Materials Science, vol. 53, (2018) pp. 4655-4664;
[5] Bei Xiang, Kit Lam, Gang Sun, Reactive and Functional Polymers, Vol. 69, Issue 12, 2009, pp. 905-914.

### GENERAL DESCRIPTION

Antifouling surfaces are mainly achievable by grafting or otherwise attaching active materials to surfaces of articles prepared in advance. The techniques used in grafting or attachment imply that at least two consecutive production steps are necessary to produce a polymer article with antifouling properties: a first step for making the article which may include polymer synthesis and shaping, and a second involving article coating or surface modification to render the article antifouling. This second stage may require additional operations on the article, such as dipping, coating, printing, gravure, drying and others, which may adversely affect production rate and economic efficiency of article production and impose additional costs.

Among the many polymers known in the art, polyolefins, and particularly low-density polyethylene (LDPE) are the most widely used polymers for food packaging, food conservation, agriculture, and healthcare applications. It is an aim of the technology disclosed herein to provide solid polymer compositions or objects that exhibit surface antifouling and antimicrobial properties, without resorting to forming a coat or a film of an antifouling material on their surface, which may be safely used in food, agricultural and healthcare applications.

Solid objects or composites of the invention comprise a polymeric bulk material that embeds or includes or contains or comprises, within the polymer bulk material (and not on its surface), at least one agent having antifouling and antimicrobial properties, or generally at least one microorganism-eradicating agent. Despite the fact that the agent is embedded within the polymer bulk material and in substantially minute amounts, as compared to the amount of the polymer, antifouling and antimicrobial properties have been observed on the object surface. The surface properties continue to exist even as the surface erodes over time, e.g., due to continuous use or friction, as the polymer bulk material acts as a reservoir containing substantially stable amounts of the at least one agent. This effect is maintained over prolonged periods of time.

Surprisingly, and against the inventors' initial expectation, the at least one agent survived high thermal extrusion conditions when a mixture of the polymer and the at least one agent were extruded to provide a solid composition. Not only that the at least one agent maintained its original properties, but its presence in the polymer bulk did also not substantially alter the mechanical, optical, chemical and other properties of the polymer. Further processing of the solid polymer object into a variety of articles of various shapes and sizes, utilizing further mechanical, thermal or chemical processing manipulations, did not have an effect on the initial properties of either the at least one agent or the polymeric material and did not require the addition of an additional antifouling material, e.g., by way of coating or grafting or generally by surface modification.

Thus, in a first of its aspects, there is provided a solid polymer composition or object or composite comprising a polymeric material and at least one agent having an antimicrobial functionality, wherein the solid polymer composition exhibits surface antifouling and antimicrobial properties.

Also provided is a solid polymer composition or object or composite comprising a polymeric material and at least one agent having an antimicrobial functionality, wherein at least a portion of the antimicrobial functionalities is surface exposed to render surface antifouling and antimicrobial properties to said solid polymer composition or object.

The invention further provides a solid reservoir of at least one antimicrobial agent, the solid reservoir comprising at least one solid polymer embedding at least one agent having an antimicrobial functionality, wherein each material fraction or aliquot derived from said solid reservoir having surface antifouling and antimicrobial properties.

The solid reservoir may be in a form of a concentrate or a masterbatch comprising a higher load of the at least one agent than usually required for achieving antifouling. The “higher load” is as defined herein.

Further provided is a solid concentrate or masterbatch, the solid concentrate or masterbatch comprising at least one solid polymer embedding at least one agent having an antimicrobial functionality, wherein the solid concentrate or masterbatch is configured to provide a plurality of solid unit amounts, wherein each solid unit amount having a predetermined amount of the at least one agent and exhibiting surface antifouling and antimicrobial properties.

In some embodiments, the concentrate or masterbatch comprises a higher load of the at least one agent than usually required for achieving antifouling. The “higher load” is as defined herein.

In some embodiments, the at least one polymer of the concentrate or masterbatch is a low melting polymer, as disclosed herein.

Also provided is a recycled polymeric object, the object comprising an amount of (i) a recycled solid polymer composition comprising at least one solid polymer embedding at least one agent having an antimicrobial functionality (this composition may be a concentrate or a masterbatch composition comprising a higher amount of the at least one agent), and, optionally, (ii) an amount of a virgin polymeric material (being in some embodiments free of at least one agent), wherein the recycled polymer and the virgin polymeric material are optionally same material.

Solid polymer compositions or objects or composites of the invention are solid objects of various shapes and sizes, at times in a form of unprocessed mass or an extruded mass or granules that exhibit surface antifouling properties, as defined. The compositions or objects are free of surface-bound or surface-functionalized antimicrobial groups or antifouling-rendering surface coating functionalities. As the solid polymer compositions may be formed by extrusion, the distribution of the at least one agent within the polymer bulk is desirably homogeneous. Thus, while the at least one agent may be homogenously distributed within the bulk, the orientation of the antimicrobial functionalities or generally the orientation of the agent within the bulk, particularly with respect of the surface, may be less controlled and/or random. Without wishing to be bound by theory, it may be assumed that a certain amount of the at least one agent or of the antimicrobial functionalities is indeed present at the surface of the polymer composition or object, namely in close proximity to the surface within the polymer bulk, at a density or distribution that is effective to provide surface antifouling properties.

The “surface antifouling and antimicrobial properties” include separate or additive antifouling properties and antimicrobial properties, encompassing antibacterial, antiviral and antifungal properties. These properties are exhibited and measurable at the surface of the solid polymer composition. When the solid composition is divided into material fractions or aliquots or into a plurality of solid unit amounts, the surface of each of the fractions, aliquots or solid unit amounts exhibits substantially the same properties. The properties, as defined, are rendered to a surface region of the composition or object or any fraction, aliquot, or unit amount thereof by the presence of the at least one agent as a whole or by at least one functionality that endows the antimicrobial properties, including the antibacterial, antiviral and antifungal properties.

In most general terms, these antifouling properties encompassing a collage of antibacterial, antiviral, and antifungal properties, including prevention and control of fouling of the surface of the solid composition or object by minimizing, diminishing, arresting or preventing adhesion of bacteria, viruses, and/or fungi. More specifically, the collage of properties include, inter alia, (i) prevention of accumulation of organisms or organism's secretion, (ii) prevention or arrest of adsorption of secretion products of cells of multicellular organisms or of microorganisms, (iii) prevention of bacterial, fungal and viral adhesion, (iv) prevention of attachment of larger organisms or cells shed from bodies of multicellular organisms, (v) eliminating or decreasing proliferation of microorganisms, (vi) prevention of biofilm generation, formation or growth, (vii) reducing or preventing quorum sensing, (viii) blocking neurotransmission, (ix) preventing adhesion of molecules and scale formation; and others. Putting it differently, solid compositions or objects according to the invention are configured to inhibit settling, attachment, accumulation and dispersion of microorganisms and/or microorganism's secretion and/or organic and/or bio-organic material (e.g., proteins and/or (poly)saccharides and/or (poly)lipids) and/or scale; and/or eliminate or decrease or prevent proliferation of microorganisms on their surface.

It was surprisingly determined that solid compositions of the invention maintain sustainable antifouling activity on the surface of the composition in the absence of surface modification of any sort. The antifouling activity of the solid compositions, including a sustainable and long-lasting antimicrobial, antifungal and antiviral activity, remains constant and consistent after multiple procedures of shaping and/or reshaping and/or recycling at temperatures as high as 200° C., and also after multiple washing cycles with water and detergents at temperatures as high as 90° C.

The polymer used for manufacturing the solid compositions may be any polymeric material used for the manufacture of polymeric products or articles. The polymer may be selected amongst polymeric materials characterized by a solid phase at room temperature. Such polymers may be selected amongst natural, synthetic or semisynthetic polymers, or blends thereof. In some embodiments, the polymer is selected amongst such polymers used for food packaging, food conservation, agriculture, and healthcare applications.

In some embodiments, the polymer is selected from thermoplastic polymers and thermosetting polymers, each as known in the art. In some embodiments, the polymer is a conductive polymer.

In some embodiments, the polymer is selected in a non-limiting fashion from polyolefins.

In some embodiments, the polymer is selected from alpha-olefin polymers and copolymers, styrene polymers and copolymers, olefin copolymers with polar monomers, polyesters, polyamides, thermoplastic elastomers and blends thereof.

In some embodiments, the polymer is selected from polyamides, poly acrylates, poly lactic acid, polybenzimidazoles, polycarbonates, polyether sulfones, polyoxymethylene, polyether ether ketone, polyetherimides, polyethylene, polyphenylene oxide, polyphenylene sulfide, polypropylene, polystyrene, polyvinyl chloride, polyvinylidene fluoride and combinations thereof.

In some embodiments, the polymer is polyethylene (PE) and/or polypropylene (PP).

In some embodiments, the polymer is polyethylene (PE). In some embodiments, the polyethylene is provided as an ultra-high molecular weight polyethylene having a molecular weight above 1000 KDa, a high molecular weight polyethylene having a molecular weight between 50 and 800 KDa, a high-density polyethylene having a density of at least 0.94 g/cm³, a low to medium density polyethylene having a density ranging between 0.91 and 0.94 g/cm³, a very low density (VLDPE) or an ultra-low density (ULDPE) having a density ranging between 0.86 and 0.91 g/cm³, a crosslinked polyethylene, and others.

In some embodiments, the polymer is a low-density polyethylene (LDPE), optionally with a density of between 0.91 and 0.93 g/cm³.

In some embodiments, the polymer is selected from polyesters, polyurethanes, epoxy-based polymers, polyimides, vinyl esters, and combinations thereof.

In some embodiments, the polymer is a mixture of two or more polymers or a blend of polymers in any suitably selected ratio.

In some embodiments, the polymer blend comprises a polymer selected from polyamides, poly acrylates, poly lactic acid, polybenzimidazoles, polycarbonates, polyether sulfones, polyoxymethylene, polyether ether ketone, polyetherimides, polyethylene, polyphenylene oxide, polyphenylene sulfide, polypropylene, polystyrene, polyvinyl chloride, and polyvinylidene fluoride.

In some embodiments, the polymer blend comprises a polyolefin.

In some embodiments, the polymer blend comprises polyethylene and/or polypropylene.

In some embodiments, the polymer is a high molecular weight polymer. In some embodiments, the molecular weight is between 50 KDa and 800 KDa. In other embodiments, the polymer molecular weight is between 50 and 100, 100 and 150, 150 and 200, 200 and 250, 250 and 300, 300 and 350, 350 and 400, 400 and 450, 450 and 500, 500 and 550, 550 and 600, 600 and 650, 650 and 700, 700 and 750, or between 750 and 800 KDa.

The polymer selected for manufacturing the solid composition or object of the invention may be selected based on its intended purpose in or contribution to the solid composition or object. In some embodiments, the polymer is selected based on its particular unique properties, such as conductivity, Tg value, molecular weight, etc., or based on its intended use, e.g., polymers suitable for use in vivo or in the medical field. Where polymer blends are used, similar considerations may be applied. In some configurations, where a polymer composition of the invention defines a recycled material intended for mixing with a virgin polymer, the two polymers may be the same or different. In cases where the two polymers are different, the two may nevertheless be selected to have substantially matching properties, i.e., the same or similar properties, e.g., both may be thermoset polymers or both may be thermoplastic.

In some embodiments, the recycled polymeric object comprises an amount of (i) a recycled solid polymer composition comprising at least one solid polymer embedding at least one agent having an antimicrobial functionality, and (ii) an amount of a virgin polymeric material. The ratio of recycled polymer to virgin polymer may be between 0.1:1 to 1:0.1.

The “virgin polymer” is a polymer which may or may not contain at least one agent, as defined. The virgin polymer may be independently selected as defined herein for the polymer constituting a solid polymer object of the invention. The virgin polymer is, in some embodiments, an unused polymer, namely not previously used in manufacturing of a product.

The polymer used in solid compositions and objects of the invention is said to “embed or include or contain or comprise” the at least one agent. In other words, the polymer acts as a matrix or a solid medium or a bulk or a mass in which the at least one agent is distributed, e.g., homogenously distributed. The at least one agent is not concentrated on the surface of the polymer object, but contained within. The containment of the at least one agent within the polymer matrix or medium or mass does not typically involve strong and irreversible chemical association or interaction, such as covalent bonding. Generally speaking, such an association is to be avoided or is not present. However, weaker and/or reversible interactions, i.e., ionic or hydrogen bonding, may take place. Therefore, the at least one agent is able to migrate within the polymer matrix; hence having a degree of mobility that enables agent migration to the surface of the object. The degree of mobility is high enough to ensure presence of the at least one agent on the surface at any time or throughout the composition or object service life, however, low enough to prevent rapid depletion of the at least one agent during the service life. The desired degree of mobility may be achieved by a proper selection of the polymer and the at least one agent.

In some embodiments, to achieve a desirable or an effective level of microorganism reducing activity, the at least one agent may be present in the polymer mass in an amount between 0.01 and 20 wt %, or between 0.5 and 10 wt %, or between 1 and 5 wt % relative to the weight of the polymer. In some embodiments, the solid reservoir is in a form of a concentrate or a masterbatch comprising a higher load or amount of the at least one agent may be used. The “higher load” or amount is typically an amount that is 2, 3, 4 or more times greater than an amount of the at least one agent necessary for achieving an effective level of microorganism reducing activity, as defined above. In some embodiments, to achieve a desirable or an effective level of microorganism reducing activity, the at least one agent may be present in the polymer mass in an amount between 0.01 and 20 wt %, a higher load or amount to be provided in a concentrate or a masterbatch may be 2, 3, 4 or more times greater. In some embodiments, the amount of the at least one agent in a concentrate or masterbatch may be between 0.02 wt % and 50 wt %, relative to the amount of the polymer.

To tailor properties of the solid polymer object, further additives may be incorporated to the polymer mass. Such additives may be selected from antimicrobial, antifungal or antiviral materials different from those defined for the at least one agent; essential oils, such as carvacrol, thymol, limonene, rosemary oil, tea tree oil and the like; metal based materials including metallic materials such as metal salts and complexes or metals; antioxidants; acid scavengers; fillers; colorants; antistatic agents; nucleating agents; clarifying agents; rheology modifying agents; antifogging agents; polarity modifying agents capable of adjusting rate of migration of the at least one agent to the surface of the polymer object, such as grafted polymers; and combinations thereof.

The amount of the additive may vary based on the particular intended use and the particular at least one agent used. In some embodiments, the additive(s) may be present in amounts ranging between 0.01 to 30 wt %, relative to the amount of the polymer. In some embodiments, the additive(s) may be present in amounts raging between 0.01 and 5 wt %, 1 and 5 wt %, 1 and 10 wt %, 1 and 20 wt %, or 3 and 30 wt %.

The at least one agent used to render compositions and objects of the invention antifouling, is an antifouling or an antimicrobial active substance that may be any such material known in the art. Such materials are disclosed for example in U.S. Pat. Nos. 9,840,627, 9,862,837, and 9,631,100, each of which being incorporated herein by reference.

The at least one agent is a material having antifouling properties due to presence of an antimicrobial functionality, or a collection of functionalities together capable of inducing or endowing the object which contains it with the antifouling/antimicrobial properties. Typically, the at least one agent is a material having a structure known to have antimicrobial properties, such as antiviral properties. In some embodiments, the material has a structure comprising one or more functionalities that is antifouling or antimicrobial, or which can induce such properties, as defined herein. In other words, the one or more functionalities can induce antibacterial, antiviral and/or antifungal properties. The one or more functionalities may be an atom or a group of atoms such as a fluor atom (—F), bromine atom (—Br), chloride atom (—Cl), an alkylene chain (which may be a short aliphatic chain, containing up to 20 atoms in the chain backbone), an alkyl group, an hydroxy group (—OH), an aryl group, or a combination of any two or more of the aforementioned atoms or groups.

In some embodiments, the hydroxy group is provided as a DOPA-substituted material.

The at least one agent may be an aliphatic material, an aromatic material, a polysaccharide, an oligomer, a short polymer (having molecular weights smaller than 10 KDa), an amino acid, a peptide and others, each having antifouling properties or comprising one or more antifouling or antimicrobial functionalities.

In some embodiments, the at least one agent is an amino acid or an amino acid sequence.

In some embodiments, the at least one agent is a peptide.

In some embodiments, the peptide comprises between 3 and 10 repeating monomers or amino acids. In some embodiments, the peptide comprises two or more amino acids. In some embodiments, one or more of said two or more amino acids are aromatic amino acids and/or amino acids having a functionality selected from —F, —Br, —Cl, —OH, an alkylene chain, an alkyl group, and an aryl group.

In some embodiments, the peptide is selected amongst:
1. peptides wherein antifouling properties are substantially due to presence of an antimicrobial functionality—such peptides may comprise at least one hydroxyaryl, such as di-, tri-, tetra- or pentahydroxyaryl moiety and at least one antimicrobial functionality. The hydroxyaryl moiety and the antimicrobial functionality may be associated directly or indirectly via a linker moiety;
2. peptides wherein the antifouling properties are attributed to the peptide as a whole—such peptides comprise at least one hydroxyaryl moiety, as defined, and at least one aromatic amino acid (such peptides may be free of, e.g., F atom(s)).

In some embodiments, the at least one agent is a peptide comprising at least one antimicrobial functionality and at least one dihydroxyaryl moiety.

In some embodiments, the hydroxyaryl moiety is a dihydroxyphenyl, such as 3,4-dihydroxy-L-phenylalanin (DOPA), or a trihydroxyaryl, a tetrahydroxyaryl or a pentahydroxyaryl. These may be various hydroxylated DOPA moieties such as hydroxy-DOPA, dihydroxy-DOPA and trihydroxy-DOPA.

In some embodiments, the dihydroxyaryl moiety is a 1,2-dihydroxyphenyl, such as a DOPA-substituting or catechol-substituting moiety.

In some embodiments, the at least one agent is a peptide containing a DOPA moiety and at least one antimicrobial amino acid or functionality such as —F or a group comprising one or more F atoms.

In some embodiments, the hydroxyaryl moiety and the antimicrobial functionality and/or the aromatic amino acid (per options 1 or 2 above) may be associated directly via a covalent bond or indirectly via a linker moiety L. The linker moiety L may have a backbone structure to which the functional moieties may be bonded or with which they may be associated. In some embodiments, the backbone structure may be further substituted by one or more pendent groups as explained hereinbelow. The backbone structure may be composed of carbon atoms and may include one or more heteroatoms such as N, O, S, and P atoms.

In some cases, the linker moiety L may not be necessary as the functional moieties may be associated or bonded directly to each other. Thus, in some embodiments, the linker moiety is absent or is a bond associating the functional moieties.

In some embodiments, where the linker moiety L is present, its backbone may comprise one or more carbon atoms. The shortest backbone may be a one-carbon chain.

In some embodiments, the linker backbone may be selected from a substituted or unsubstituted carbon chain which may be saturated or unsaturated, having only single bonds, hydrocarbons comprising one or more double bonds, or one or more triple bonds, or comprising any one or more functional groups which may be pendent on the backbone moiety or as an interrupting group (being part of the backbone).

In some embodiments, the backbone comprises one or more inner-chain aryl groups.

In some embodiments, the linker moiety L is an organic backbone moiety selected from substituted or unsubstituted oligomer (having between 2 and 11 repeating units) or polymer (having at least 12 repeating units).

In some embodiments, the linker moiety L is an organic backbone moiety selected from amino acids and peptides.

In some embodiments, the backbone may comprise between 1 to 40 carbon atoms or hydrocarbon groups or any heteroatom which may be positioned along the backbone (in the main chain). In some embodiments, the backbone may comprise between 1 to 20 carbon atoms. In some embodiments, the backbone may comprise between 1 to 12 carbon atoms. In some embodiments, the backbone may comprise between 1 to 8 carbon atoms. In some embodiments, the backbone may comprise 1 or 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 or 31 or 32 or 33 or 34 or 35 or 36 or 37 or 38 or 39 or 40 carbon atoms.

In some embodiments, the linker moiety L may be constructed of a predetermined number of repeating units which may or may not be randomly structured along the backbone. The linker moiety L may be substituted by one or more functional groups such as substituted or unsubstituted alkyl, substituted or unsubstituted alkenyl, substituted or unsubstituted alkynyl, substituted or unsubstituted cycloalkyl, substituted or unsubstituted cycloalkenyl, substituted or unsubstituted cycloalkynyl, substituted or unsubstituted aryl, substituted or unsubstituted heteroaryl, substituted or unsubstituted heterocyclyl, substituted or unsubstituted —NR₁R₂, substituted or unsubstituted —OR₃, substituted or unsubstituted —SR₄, substituted or unsubstituted —S(O)R₅, substituted or unsubstituted alkylene-COOH, and substituted or unsubstituted ester.

The variable group denoted by “R” (including any one of R₁, R₂, R₃, R₄, R₅) refers to one or more group selected from hydrogen, alkyl, alkenyl, alkynyl, cycloalkyl, cycloalkenyl, cycloalkynyl, aryl, heteroaryl, heterocyclyl, halogen, alkylene-COOH, ester, —OH, —SH, and —NH₂, as defined herein or any combination thereof.

Each of the abovementioned groups, as indicated, may be substituted or unsubstituted. The substitution may also be by one or more R, selected from hydrogen, alkyl, alkenyl, alkynyl, cycloalkyl, cycloalkenyl, cycloalkynyl, aryl, heteroaryl, heterocyclyl, halogen, alkylene-COOH, ester, —OH, —SH, and —NH₂. In some embodiments, the number of R groups may be 0 or 1 or 2 or 3 or 4 or 5 or 6 or 7 or 8 or 9 or 20.

In some embodiments, the backbone chain may comprise one or more heteroatoms (e.g., N, O, S and P). In some embodiments, the backbone chain may comprise an inner-chain ester and/or carbonyl and/or amine group and/or amide group.

In some embodiments, the backbone chain may be of the general structure:

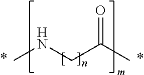

wherein
each * denotes a point of connectivity;
n is between 0 and 40; and
m is between 1 and 40.

In some embodiments, n is between 1 and 12. In some embodiments, n is between 1 and 8. In some embodiments, n is between 1 and 6.

In some embodiments, m is between 1 and 20. In some embodiments, m is between 1 and 12. In some embodiments, m is between 1 and 8. In some embodiments, m is between 1 and 6.

In some embodiments, one or more of the (CH₂)n groups are substituted. In some embodiments, the substitution group is a substituted or unsubstituted phenyl. In some embodiments, the substitution group is hydroxylated or fluorinated phenyl.

In some embodiments, the backbone chain comprises an amino acid group; thus, in the above general formula of a representative linker backbone, the repeating unit (being repeated m times) is an α- or β-amino acid (wherein n is 1, or n is 2, respectively).

In some embodiments, the linker moiety L is an amino acid or a peptide comprising 2 or 3 or 4 or 5 or 6 or 7 or 8 or 9 or 10 or 11 or 12 or 13 or 14 or 15 or 16 or 17 or 18 or 19 or 20 or 21 or 22 or 23 or 24 or 25 or 26 or 27 or 28 or 29 or 30 or 31 or 32 or 33 or 34 or 35 or 36 or 37 or 38 or 39 or 40 amino acids.

In some embodiments, the at least one agent is constructed of two amino acids bonded to each other via an amide bond (constituting the linker L), wherein one amino acid is DOPA and the other is a fluorinated amino acid, as described herein. In some embodiments, the at least one agent is constructed of two amino acids: DOPA and a fluorinated amino acid, said two amino acids being associated to each other via a linker moiety as described herein. In some embodiments, the linker moiety is one or more amino acid.

In some embodiments, the backbone comprises one or more DOPA or catechol group containing moiety and one or more antifouling moieties.

In some embodiments, the backbone comprises 1 or 2 or 3 or 4 or 5 or 6 or 7 or 8 or 9 or 10 or 11 or 12 or 13 or 14 or 15 or 16 or 17 or 18 or 19 or 20 DOPA or catechol moieties. In some embodiments, the backbone comprises 1 or 2 or 3 or 4 or 5 or 6 or 7 or 8 or 9 or 10 or 11 or 12 or 13 or 14 or 15 or 16 or 17 or 18 or 19 or 20 antifouling functionalities.

In some embodiments, the antimicrobial functionalities are bonded to the backbone at one end and the DOPA or catechol moiety at the other end of the backbone. In other embodiments, the antimicrobial functionalities and the DOPA or catechol moiety are at alternating positions along the backbone. In other embodiments, the antimicrobial functionality and the DOPA or catechol moiety are randomly positioned along the backbone.

In some embodiments, the backbone comprises one or more amino acids units or hydrocarbon units, the backbone having a plurality of DOPA or catechol moieties and a plurality of antimicrobial functionalities, wherein the distance between the two moieties, either DOPA or catechol or antifouling moieties, does not exceed 12 units, 6 units, 3 units or 1 to 5 units.

In some embodiments, the backbone comprises or consists a peptide of two or more amino acids. In some embodiments, the at least one agent is a peptide having at least two amino acids, at least one DOPA and at least fluorinated group, which may or may not be a fluorinated amino acid.

In some embodiments, the peptide comprises between 2 and 40 amino acids. In some embodiments, the peptide comprises between 2 and 20 amino acids. In some embodiments, the peptide comprises between 2 and 12 amino acids. In some embodiments, the peptide comprises between 2 and 8 amino acids. In other embodiments, the peptide comprises between 2 and 6 amino acids, or between 2 and 4 amino acids, or has 2 or 3 amino acids. In some embodiments, the peptide comprises 2, or 3, or 4, or 5, or 6, or 7, or 8 or 9 or 10 or 11 or 12 amino acids.

In some embodiments, the at least one agent is a peptide, as defined, having at least one DOPA or catechol moiety and at least one antimicrobial amino acid. Where the peptide is constructed of two amino acids, one of which is an antimicrobial amino acid and the other is a DOPA. Where the number of amino acids in the peptide is greater than 2, the number of each type of amino acids may vary in accordance with the target final use.

As known in the art, a “peptide” comprises amino acids, typically between 2 and 40, or between 2 and 20, or between 2 and 12 or between 2 and 8; each amino acid being bonded to a neighboring amino acid via a peptide (amide) bond. The peptidic backbone may be modified such that the bond between the N— of one amino acid residue to the C— of the next amino acid residue is altered to non-naturally occurring bonds by reduction (to CH₂—NH—), alkylation (e.g., methylation) on the nitrogen atom, or the bonds replaced by amidic bond, urea bonds, sulfonamide bond, etheric bond (—CH₂—O—), thioetheric bond (CH₂—S—), or —CS—NH. The peptide may further comprise one or more non-amino acid group.

In some embodiments, the at least one agent is a peptide having two or more DOPA or catechol moieties grouped at the C-terminal of the peptide, and one or more antimicrobial amino acids (e.g., aromatic amino acids or fluorinated amino acids) comprising positioned or grouped at the N-terminal of the peptide. In other embodiments, the DOPA or catechol moiety/moieties is/are positioned or grouped at the N-terminal of the peptide, and the antimicrobial amino acids are grouped at the C-terminal of the peptide.

In some embodiments, at least one DOPA or catechol moiety is positioned at one of the peptide termini (either the C-terminal or the N-terminal), and at least one antimicrobial amino acids is positioned at the other of the peptide termini.

In some embodiments, the at least one DOPA or catechol moiety is positioned at a midpoint position between the C-terminal of the peptide and the N-terminal of the peptide, and one or more antimicrobial amino acids are positioned each at each of the peptide termini.

In some embodiments, the peptide may comprise any one or more amino acids along the chain, e.g., positioned between the termini functional amino acids, positioned randomly along the peptide or at specific positions thereof in order to affect one or more additional structural or functional attributes. In some embodiments, the one or more amino acids may or may not be aromatic amino acids.

The end C- or N-termini of the peptide may be modified to affect or modulate (increase or decrease or generally change) one or more property of the peptide, e.g., a structural change, hydrophobicity/hydrophilicity, charge, solubility, surface adhesion, toxicity to organisms, biocompatibility, resistance to degradation in general and enzymatic degradation in particular and others. The C- or N-termini of the peptide may be chemically modified by forming an ester, an amide, or any other functional group at the desired position; such that the peptides may have an amine at one end thereof (the N-terminal) and a carboxyl group (the C-terminal) at the other end, or may have others groups at either of the termini.

In some embodiments, the peptide is an antifouling material that is free of a distinct antifouling functionality such as F. Thus, in some embodiments, the peptide comprises a DOPA or catechol moiety linked to at least one aromatic amino acid, wherein the peptide is free of an antifouling group (such as F).

In some embodiments, the aromatic amino acid is selected from phenylalanine, tryptophan and tyrosine. In some embodiments, the aromatic amino acid is phenylalanine. The number of aromatic amino acids may vary between 1 and 20. In some embodiments, the number of aromatic amino acids is between 1 and 5, or is 1, 2, 3, 4, or 5.

In some embodiments, the solid polymer compositions or objects of the invention comprise a polymer and a peptide, each as defined herein. The polymer may be any commercially available polymer, e.g., a thermoplastic polymer, or any synthetic or semisynthetic polymer. In some embodiments, the polymer is selected amongst alpha-olefin polymers and copolymers, styrene polymers and copolymers, olefin copolymers with polar monomers, polyesters, polyamides, thermoplastic elastomers and blends thereof. In some embodiments, the polymer is polypropylene or polyethylene.

The polymer may be any of the polymers disclosed herein.

The at least one agent, being in some embodiments a peptide, may be selected amongst such having between 2 and 20 amino acids, as described herein.

In some embodiments, the peptide is present in solid compositions according to the invention in amounts ranging between 0.01 and 20 wt %, or between 0.5 and 10 wt %, or between 1 and 5 wt %. Insufficiently low peptide content results in reduced and shortened antifouling, antimicrobial and antiviral activity.

In some embodiments, the at least one agent is a peptide selected amongst dipeptides, tripeptides, tetrapeptides and pentapeptides.

In some embodiments, the peptide is provided in combination with at least one additive, as disclosed herein. In some embodiments, the additive is at least one metal-based material. The metal-based material being a metal salt, a metal complex or a metal particle (nano or microparticle). In some embodiments, the metal-based material is an antimicrobial material. In some embodiments, the metal atom in a metal-based material is copper, zinc, silver and others.

In some embodiments, the at least one agent is a peptide selected from
-DOPA-Phe(4F)-Phe(4F)—OMe,
-DOPA-Phe-Phe(4F)—OMe,
-DOPA-Phe(4F)-Phe-OMe,
-DOPA-Phe-Phe-OMe,
-DOPA-Phe,
-DOPA-Phe(4F),
-DOPA-L-Phe(4F),
-DOPA-L-Phe,
-DOPA-L-Phe(4F)-Phe(4F)—OMe,
-DOPA-L-Phe-Phe(4F)—OMe,
-DOPA-L-Phe(4F)-Phe-OMe,
-DOPA-L-Phe-Phe-OMe,
wherein DOPA as is defined herein, Phe is phenylalanine and Phe(4F) is a phenyl alanine moiety substituted with an F atom at the 4 position of the phenyl ring. OMe stands for a methylated oxygen atom. Variant L is a linker moiety, as defined herein.

In some embodiments, the peptide is -DOPA-Phe(4F)-Phe(4F)—OH or an ester thereof (wherein the O atom is alkylated, e.g., methylatd to provide —OMe),

In some embodiments, the solid compositions of the invention comprise a polymer and a peptide, wherein the peptide is provided in a form of a particulate matter, e.g., porous particles, which may optionally contain additives or other components. Such additives may be selected amongst essential oil, for example thymol or carvacrol. Incorporation of essential oil into the composition or into peptide particles allows a solid composition to withstand high temperatures of polymer processing, despite low evaporation temperatures of the essential oils. Such compositions, comprising polymers, peptides and essential oils demonstrate improved antimicrobial and antiviral performance. Particularly, such compositions demonstrate stronger and longer lasting microorganism suppressing activity at lower essential oil concentrations as compared with conventional antimicrobial compositions.

In some embodiments, the peptide is provided as peptide particles (namely wherein the peptide is provided in a particulate form).

In some embodiments, the composition of the invention comprises at least one essential oil. The essential oil may be any of those known in the art. These include agar oil, ajwain oil, Angelica root oil, anise oil, asafoetida oil, balsam of Peru, Basil oil, bay oil, bergamot oil, black pepper oil, buchu oil, birch oil, camphor oil, cannabis flower essential oil, calamodin oil, caraway seed oil, cardamom seed oil, carrot seed oil, cedar oil, chamomile oil, calamus oil, carvacrol oil, cinnamon oil, cistus ladanifer leaves oil, citron oil, citronella oil, clary sage oil, coconut oil, clove oil, coffee oil, coriander oil, costmary oil, Costus root oil, cranberry seed oil, cubeb oil, cumin seed oil, cypress oil, cypriol oil, curry leaf oil, Davana oil, dill oil, elecampane oil, elemi oil, Eucalyptus oil, fennel seed oil, fenugreek oil, fir oil, frankincense oil, galangal oil, Galbanum oil, garlic oil, geranium oil, ginger oil, goldenrod oil, grapefruit oil, henna oil, Helichrysum oil, hickory nut oil, horseradish oil, hyssop oil, Idaho-grown tansy oil, jasmine oil, juniper berry oil, Laurus nobilis oil, lavender oil, lemon oil, Litsea cubeba oil, linalool, mandarin oil, Melissa oil, mint oil, Moringa oil, mountain savory, mugwort oil, mustard oil, neem oil, orange oil, oregano oil, orris oil, parsley oil, patchouli oil, pennyroyal oil, peppermint oil, pine oil, red cedar oil, rose oil, rosemary oil, sage oil, sandalwood oil, Sassafras oil, savory oil, spearmint oil, star anise oil, tarragon oil, tea tree oil, thyme oil, thymol oil, turmeric oil, western red cedar oil, wintergreen oil, yarrow oil, and others.

In some embodiments, the essential oil is thymol or carvacrol.

Thus, in some embodiments, the solid compositions or objects of the invention further comprise at least one essential oil. In some embodiments, the essential oil is thymol or carvacrol. In some embodiments, the at least one essential oil is provided within peptide particles.

Solid compositions of the invention may be manufactured by any method known in the art. In some embodiments, the solid compositions are formed by compounding, wherein the at least one agent and optionally any further additive is/are added to a polymer in a molten form. The compounding may be performed in a batch mode, using a batch mixer, such as a Banbury mixer. Alternatively, the compounding may be performed in a continuous mode, using a single-screw or twin-screw extruder, continuous melt mixer, co-kneader or combinations thereof. The temperatures of the melt mixing during the preparation of the composition may be above the peak melting temperature or softening temperature of the polymer, yet below a temperature at which the at least one agent, e.g., peptide, degrades. In some embodiments, the temperature is in a range of 100 to 200° C. or between 120 and 180° C.

Thus, in another aspect, the invention provides an extruded solid polymer composition comprising a polymeric material and at least one agent having an antimicrobial functionality, wherein the solid polymer composition exhibiting surface antifouling and antimicrobial properties.

In some embodiments, the solid composition may be prepared directly in a course of manufacturing of a final article by melt blending of a virgin polymer, optionally comprising one or more additives, with a solid polymer composition according to the invention, acting as a polymer concentrate or a polymer masterbatch comprising the at least one agent, and optionally comprising one or more additives, wherein the virgin polymer and the polymer of the concentrate are same or different. Where the two polymers are the same, such a methodology may be used to recycle polymers containing the at least one agent or to enrich a virgin polymer with the at least one agent.

Where the virgin polymer and the polymer of the concentrate may be different, such a methodology may be used where the at least one agent, e.g., a peptide, is sensitive to temperatures and/or to shear stress. In such cases, the concentrate or masterbatch may contain a polymer or a polymer blend having a lower melting point and/or lower viscosity than the matrix polymer used to manufacture the solid composition or object.

Articles made from solid compositions or objects of the invention may be numerous and may be tailored for specific applications or uses. Articles of the invention include at least one part or element made of a solid polymer composition of the invention. In some embodiments, the articles comprise or consist a solid polymer composition according to the invention.

The articles may be tailored for agricultural use, for ornamental or decorative use; for storage and packaging; for containment of various materials such as drugs, foods, liquids, electronic elements and others; for containment or for coating of oxygen- or water-sensitive materials; for surface coating; for medical uses; for veterinary use, and others.

The articles may be rigid and flexible packaging, containers, crates, bins, toys, household items, gloves, curtains, masks, sticky surfaces, coating materials, parts of appliances, automotive parts, knobs, grips, handles, pipes, tubes, sheet, films, bottles, canisters, fibers, woven and nonwoven textiles, profiles and others.

In some embodiments, the solid polymer composition or object is a film or a sheet. In some embodiments, the solid polymer composition or object is processed into a film or a sheet by utilizing any method known in the art, e.g., by compression.

In some embodiments, the film or sheet having a thickness of several microns to several hundred microns or few millimeters. In some embodiments, the film or sheet having a thickness of between 50 and 500 μm.

The articles may be multicomponent, combining a composition of the invention with other polymer compositions. In some embodiments, such articles may be multilayered, wherein certain layers are made of a composition of the invention, and other layers are made of different polymer or non-polymer materials. The multilayered articles may include parts, laminates, coated, welded and glued parts, which may be co-extruded. Particularly, such multilayered parts may comprise barrier layers, allowing migration of antifouling agents to specific surfaces, but preventing their migration to other.

Articles of the invention may be manufactured by any method of polymer processing known in the art. These include, but are not limited to, injection molding, sheet or film extrusion (either cast or blown), profile or pipe extrusion, blow molding, thermoforming, compression molding, fiber spinning, gluing, welding, assembling and others.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-D are SEM images of peptide assemblies. (A and B) before and (C and D) after lyophilization at high and low magnifications.

FIG. 2 provides a schematic illustration of the compounding process. (a) The peptide assemblies are being lyophilized to yield a powder, (b) the peptide powder is mixed with pellets of LDPE. (c) This mixture is then being inserted into the compounder. (d) The resulted polymer granules are later being compressed to generate PE films.

FIGS. 3A-F depict surface characterization of polyethylene films. Optical images of (A) neat LDPE films and (D) LDPE compounded with the peptide (PEP), SEM images of (B) neat LDPE and (E) PEP films, and CLSM of neat LDPE and (C) PEP films (F).

FIGS. 4A-C depict the physical characterization of PE films. Thermogravimetric analysis of the peptide structure (A), polyethylene (B), and polyethylene compounded with the peptide assemblies (top graph in B). (C) FT-IR spectra of polyethylene (lower graph) and polyethylene compounded with peptide assemblies (top graph).

FIGS. 5A-C present antimicrobial assays of the polymer films. (A) Antiviral, (B) antibacterial, and (C) antifungal results for the two films: neat polyethylene (PE) and polyethylene compounded with peptide assemblies (PEP) films. Standard deviation (SD) is based on three independent experiments with triplicates (n=9) for antiviral and antibacterial assays and two independent experiments with quintuplicate for antifungal assay (n=10).

### DETAILED DESCRIPTION OF EMBODIMENTS

Materials. DOPA-Phe(4F)-Phe(4F)—OMe was obtained from GL Biochem (Shanghai) Ltd. with a purity>95%. LDPE was obtained from Carmel Olefines Ltd. (Israel). Ethanol 200 proof was purchased from Gadot. E. coli strain (ATCC 25922) and E. coli bacteriophage T4 (ATCC 113030-B4) bacteria were purchased from the American Type Culture Collection (ATCC, Manassas, Virginia, USA). LB broth was purchased from Becton Dickinson (New Jersey, USA). Agar was purchased from Merck (New Jersey, USA). Agarose was obtained from LifeGene (Israel). Deionized (DI) water was obtained by filtering distilled water through a Milli-Q water system.

Pythium sp. was originally isolated from infected potato tubers and kept on agar slants. Czapek-Dox agar was prepared as previously indicated.

Preparation of the peptide assembly powder. The peptide was dissolved in ethanol (100 mg/ml) and then diluted in water (10 mg/ml). This solution was shaken for 0.5 h at room temperature and frozen in liquid nitrogen. Afterward, the frozen sample was lyophilized in freeze-drier (Lyophilizer Heto Drywinner3-Heto) under vacuum at −40° C. and 0.001 atmospheres until dry.

Preparation of PE films. Low-density polyethylene (LDPE), Ipethene 320 (supplied by Carmel Olefins Ltd., Haifa, Israel) with a melt flow rate of 2 g/10 min was melt compounded at 160° C. with peptide assembly powder (4 wt %) using Rheomix polylab system (Rheomix 600p, Thermo Haake, Germany) with a blades speed of 50 rpm for 10 minutes. Subsequently, films with a thickness of 100 μm were prepared by compression molding (P200E, Dr. Collin, Germany) at 160° C., for about 10 seconds.

Scanning electron microscopy (SEM). SEM images were performed using a high-resolution scanning electron microscope Sirion XL30 SFEG (ThermoFisher, former FEI) at an acceleration voltage of 5 kV and a working distance of 5 mm.

Laser confocal scanning microscope (CLSM). CLSM images were done using FV-1200 confocal microscope (Olympus. Japan) and a 60×/1.42 oil immersion objective. Green fluorescence was observed with a 488 nm excitation filter and 500-540 nm emission filter.

Thermogravimetric analysis (TGA). TGA measurements were performed using the TGA Q5000 system (TA instruments, USA) at a heating rate of 10° C./min under nitrogen atmosphere, starting from room temperature to 800° C. The results were analyzed using Universal Analysis 200 version 4.5 A build 4.5.0.5 software.

Fourier-transform infrared spectroscopy (FT-IR). FT-IR spectra were recorded using a Nicolet 6700 FT-IR spectrometer with a deuterated triglycine sulfate (DTGS) detector (Thermo Fisher Scientific, MA, USA). Polymer films were placed on a CaF₂ plate. The measurements were taken in the range of wave number 400 to 4000 cm⁻¹ using a 4 cm⁻¹ resolution and averaged after 2000 scans.

X-ray photoelectron spectroscopy (XPS). XPS measurements were performed using Kratos AXIS Supra spectrometer (Kratos Analytical Ltd., Manchester, U.K.) with Al Kα monochromatic radiation X-ray source (1486.6 eV). The XPS spectra were acquired with a takcoff angle of 90° (normal to analyzer); the vacuum condition in the chamber was 2×10−9 Torr. The survey spectra were measured with pass energy 160 eV and 1 eV step size and high-resolution XPS spectra with a pass energy of 20 and 0.1 eV step size. The binding energies were calibrated using C 1 s peak energy as 285.0 eV. Data were collected and analyzed by using the ESCApe processing program (Kratos Analytical Ltd.) and Casa XPS (Casa Software Ltd.).

Contact angle measurements. The water contact angle was measured using a Theta Lite Optical Tensiometer (Attension Theta, Finland). The volume of each drop was 0.5 μL. The measurements were done at 4 locations on 3 independent surfaces and averaged.

Antiviral activity assay. The antiviral activity of the polymer films was done by using bacteriophage T4 as the virus for antiviral activity measurements. The preparation of the bacteriophage suspension was based on the previously described method. Briefly, the phages were propagated on E. coli and collected by centrifugation. The phage concentration was determined using the soft agar overlay technique. The virus suspension was 10-fold serially diluted and then, a 16 μL drop of 10⁶ pfu/ml viral suspension was placed on each surface and incubated under the humid condition at room temperature for 24 h. Afterward, the phages were harvested by shaking soybean casein digest broth with lecithin and polysorbate (SCDLP) broth to stop the incubation. The bacteriophage T4 in SCDLP was diluted ten times, and the samples with bacteria were mixed agarose. Finally, the mixture was spread on LB agar, and the plate was incubated at 37° C. overnight to form the plaques.

Antibacterial activity assay. The antibacterial activity of the polymer films was done by using E-coli. A drop (15 μL) of E. coli solution, at a concentration of 10⁶ cfu/ml, was placed on each surface and incubated overnight at 37° C. under the humid condition for 24 h. Then, the surfaces were sonicated in 3 ml PBS (pH=7.4) solution for 1 min and decimally diluted, seeded on LB agar plate (15 μL), and counted the colonies.

Antifungal activity assay. The antifungal activity of the polymer films was done by using Pythium sp. The polymer films with a diameter of 6 cm were perforated to obtain 10 pinholes/cm². The perforated plastic film was laid on Czapek-Dox agar in a Petri dish. Then, the mycelium disc (5 mm) of Pythium sp. was placed on the center of the polymer film and incubated at 25° C. After 5 days, the diameter of each colony was measured, and the colony area was calculated. The inhibition ratio was calculated based on the surface area of the Pythium sp. growth on neat LDPE with no additional additives.

### RESULTS AND DISCUSSION

The tripeptide DOPA-Phe(4F)-Phe(4F)—Ome self-assembles into spherical structures with antiviral activity. To acquire LDPE polymeric films with an antiviral activity, peptide assemblies of the tripeptide were lyophilized and incorporated into the LDPE by compounding.

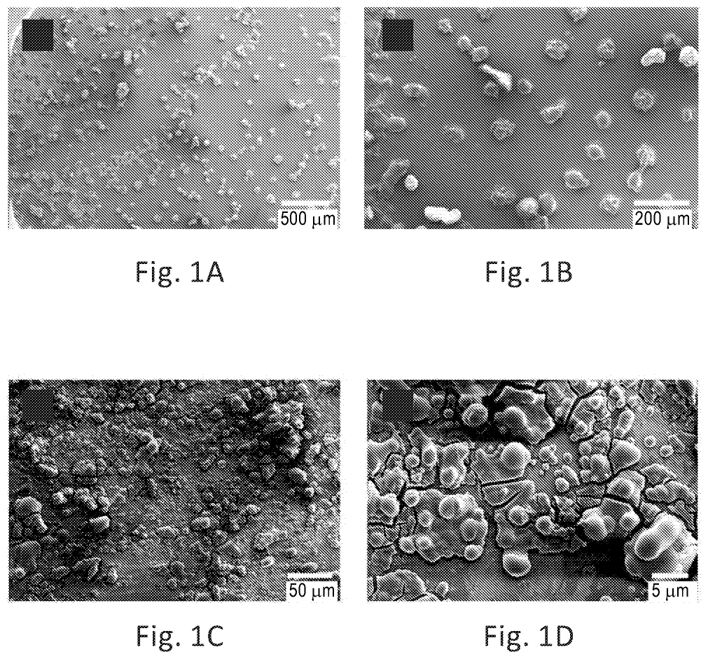

To verify that the lyophilization did not harm the morphology of the assemblies, SEM analysis was performed. FIG. 1 displays scanning electron microscope (SEM) micrographs of the tripeptide assemblies, e.g., as capsules, before and after lyophilization at different magnifications. It can be seen that the spherical structures were not damaged by the lyophilization process and maintained their spherical structure.

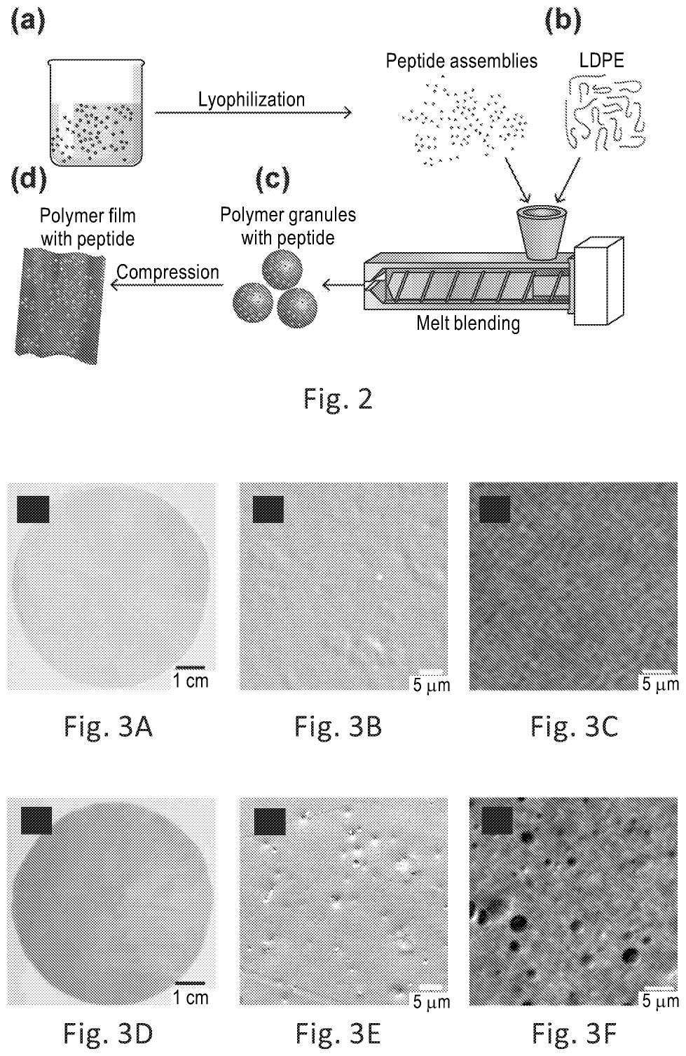

After lyophilization, LDPE pellets (96% wt) were melt-compounded with the peptide assemblies in powder form (4 wt %) at 160° C. The resulting polymer granules were compressed to generate PE films with a thickness of 100 μm, following a procedure exemplified in FIG. 2.

The LDPE films that incorporated the peptide assemblies had a yellowish color compared to the neat LDPE films (FIGS. 3A and 3D). This is probably due to the DOPA residues in the peptide. Scanning electron microscopy and laser confocal scanning microscope (CLSM) of the films revealed the presence of spherical particles in the LDPE films compounded with the peptide (FIGS. 3E-F), while the film made with only PE showed a relatively smooth surface (FIGS. 3B-C). The fluorescence behavior of the peptide assemblies (FIG. 3F) agrees with an earlier observation that diphenylalanine assemblies can have fluorescent emission.

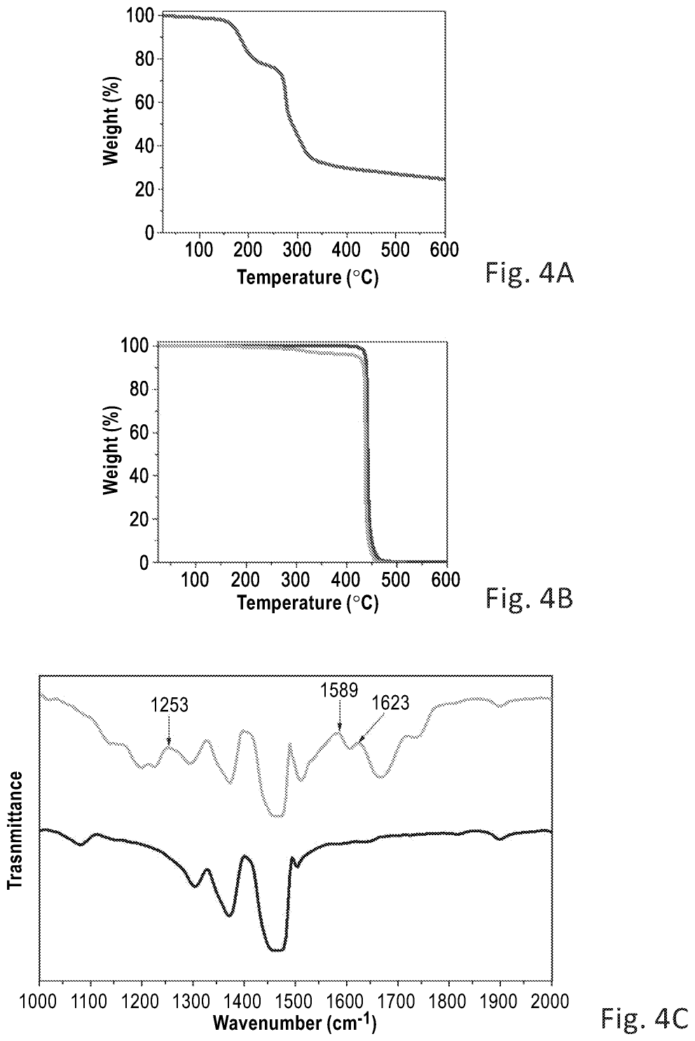

Thermogravimetric analysis (TGA) was employed to analyze the stability of the materials. The thermographs of the peptide assemblies are characterized by four major decomposition peaks (FIG. 4A). The first decomposition peak (T<100° C., 0.9%) can be attributed to water absorption onto the powder. The other three peaks (at T=175° C., 273ºC, and 308° C.) characterize the decomposition profile of the peptide.

The compounding process and compression molding of the LDPE films was performed at 160° C.; therefore, the stability of the peptide under this temperature was essential. As depicted in FIG. 4A, at 160° C., the weight loss of the peptide was relatively low (<3 wt %) and contained the absorbed water. FIG. 4B presents the thermographs of neat LDPE (PE) and LDPE compounded with peptide (PEP). Neat PE film showed a weight loss above 380° C., corresponding to the decomposition of the polymer chains. Therefore, the weight loss of PEP film under 380° C. (3.5%) was attributed to the decomposition of the peptide in the PEP films. A minimal amount of peptide was lost during the processing (compounding and compression) and the PEP films contained 3.5% peptide.

To explore the change in the film composition after adding the peptide to the LDPE films, a Fourier-transform infrared spectroscopy (FT-IR), X-ray photoelectron spectroscopy (XPS), and contact angle analysis (Table 1) were performed. PEP film revealed new peaks at 1253, 1589, and 1623 cm⁻¹. The peak at 1253 cm⁻¹ was assigned to the C—N stretching of the primary aromatic amine, and the peaks at 1589 and 1623 cm⁻¹ were assigned to the N—H bending of the amine group. XPS analysis indicated that the amount of oxygen increased in the peptide compounded film from 0.9% in neat LDPE to 5.2% in PEP. This increase was due to the presence of oxygen in the peptide. Surprisingly, fluorine was not detected in PEP, probably due to the negligible amount of fluorine on the surface. This was supported by the contact angle measurements that indicated the same contact angle (˜100 degrees) for the two different surfaces.

TABLE 1
Surface elemental composition and contact angle of polyethylene
and polyethylene compounded with the peptide assemblies.

| | | | | | contact |
|---|---|---|---|---|---|
| | mass concentration [%] | | | | angle |
| surface | C_{1 s} | N_{1 s} | O_{1 s} | F_{1 s} | [degree] |
| PE | 98.9 ± 0.3 | 0.2 ± 0.1 | 0.9 ± 0.3 | 0 | 100 ± 3 |
| PEP | 94.7 ± 0.3 | 0.13 ± 0.08 | 5.2 ± 0.4 | 0 | 101 ± 2 |

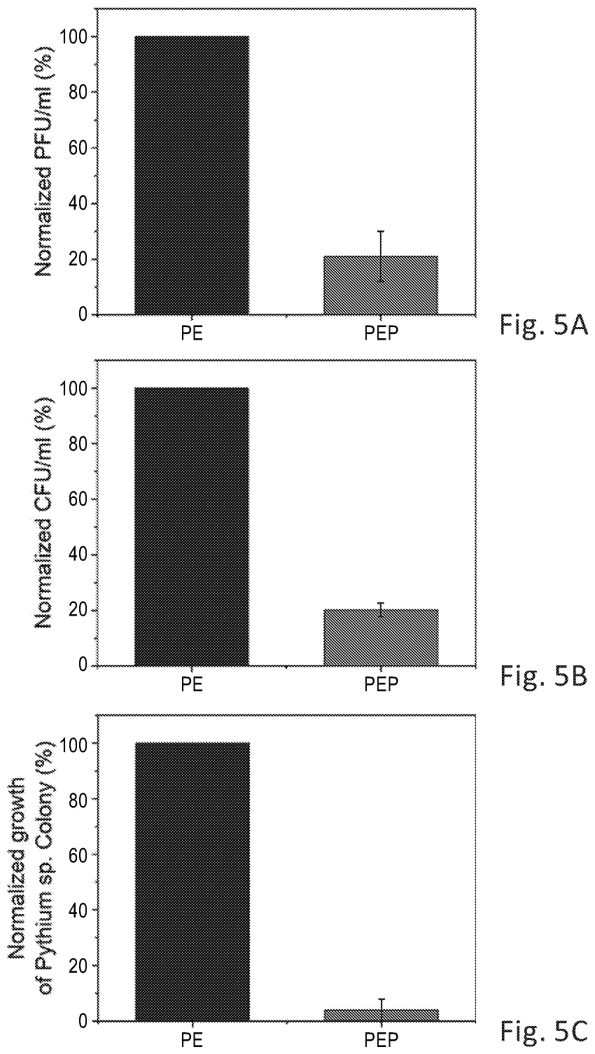

To examine the antimicrobial activity of the neat LDPE versus LDPE compounded with the peptide assemblies, performed three different assays were carried out. For the antiviral activity, the polymer films were exposed to 10⁶ PFU/mL virus suspension for 24 h. For the antibacterial activity of the surfaces, the polymer films were exposed to 10⁶ CFU/mL bacteria overnight. For fungal growth inhibition, the polymer films were laid on a solid agar medium and tested the growth of Pythium sp. after five days. LDPE compounded with the peptide assemblies demonstrated a remarkable inhibition of the viruses, bacteria, and fungi activity by 79±9% (FIG. 5A), 80±2% (FIG. 5B), and 96±5% (FIG. 5C), respectively. The antiviral activity of the peptide-compounded film was in agreement with an earlier observation, where the peptide assemblies were deposited on the glass surface and acted against T4 phage and canine coronavirus. It may be predicted that the peptide assemblies interfere with the viral assembly. The peptide antibacterial and antifungal activity might be attributed to the catechol moieties of DOPA.

1.-47. (canceled)

48. A solid polymer composition or object or composite comprising a polymeric material and at least one agent having an antimicrobial functionality, wherein at least a portion of the antimicrobial functionalities is surface exposed to render surface antifouling and antimicrobial properties to said solid polymer composition or object, wherein the solid composition or object are free of surface-coated antimicrobial agents, wherein the polymeric material and the at least one agent are not chemically associated, and wherein the at least one agent having an antimicrobial functionality having an amino acid sequence comprising 3,4-dihydroxy-L-phenylalanin (DOPA).

49. A solid reservoir composition of at least one antimicrobial agent, the solid reservoir composition comprising at least one solid polymer embedding the at least one antimicrobial agent having an antimicrobial functionality, wherein each material fraction or aliquot derived from said solid reservoir having surface antifouling and antimicrobial properties, wherein the solid composition is free of surface-coated antimicrobial agents, wherein the solid polymer and the at least one microbial agent are not chemically associated, and wherein the at least one antimicrobial agent having an amino acid sequence comprising 3,4-dihydroxy-L-phenylalanin (DOPA).

50. A recycled polymeric object, the object comprising an amount of (i) a recycled solid polymer composition comprising at least one solid polymer embedding at least one antimicrobial agent having an antimicrobial functionality, and optionally (ii) an amount of a virgin polymeric material, wherein the recycled polymer and the virgin polymeric material are optionally same material, and wherein the at least one agent having an antimicrobial functionality having an amino acid sequence comprising 3,4-dihydroxy-L-phenylalanin (DOPA).

51. The composition or object according to claim 48, wherein the at least one solid polymer is selected from thermoplastic polymers, thermosetting polymers and conductive polymers.

52. The composition or object according to claim 48, wherein the at least one solid polymer is selected from alpha-olefin polymers and copolymers, styrene polymers and copolymers, olefin copolymers with polar monomers, polyesters, polyamides, thermoplastic elastomers and blends thereof.

53. The composition or object according to claim 48, wherein the at least one solid polymer is selected from polyamides, poly acrylates, poly lactic acid, polybenzimidazoles, polycarbonates, polyether sulfones, polyoxymethylene, polyether ether ketone, polyetherimides, polyethylene, polyphenylene oxide, polyphenylene sulfide, polypropylene, polystyrene, polyvinyl chloride, polyvinylidene fluoride and combinations thereof.

54. The composition or object according to claim 53, wherein the at least one solid polymer is polyethylene (PE) and/or polypropylene (PP).

55. The composition or object according to claim 48, wherein the at least one solid polymer is selected from polyesters, polyurethanes, epoxy-based polymers, polyimides, vinyl esters, and combinations thereof.

56. The composition or object according to claim 48, wherein the at least one agent is free to migrate within the polymer matrix.

57. The composition or object according to claim 48, wherein the wherein the at least one agent having an amino acid sequence is a peptide comprising two or more amino acids.

58. The composition or object according to claim 48, wherein the at least one agent is a peptide selected amongst dipeptides, tripeptides, tetrapeptides and pentapeptides.

59. The composition or object according to claim 48, wherein the at least one agent is any one or more peptides selected from
-DOPA-Phe(4F)-Phe(4F)—OMe,
-DOPA-Phe-Phe(4F)—OMe,
-DOPA-Phe(4F)-Phe-OMe,
-DOPA-Phe-Phe-OMe,
-DOPA-Phe,
-DOPA-Phe(4F),
-DOPA-L-Phe(4F),
-DOPA-L-Phe,
-DOPA-L-Phe(4F)-Phe(4F)—OMe,
-DOPA-L-Phe-Phe(4F)—OMe,
-DOPA-L-Phe(4F)-Phe-OMe,
-DOPA-L-Phe-Phe-OMe,
wherein DOPA as is defined herein, Phe is phenylalanine and Phe(4F) is a phenyl alanine moiety substituted with an F atom at the 4 position of the phenyl ring, and wherein L is a linker moiety.

60. The composition or object according to claim 48, further comprising at least one essential oil.

61. The composition or object according to claim 48, manufactured by compounding.

62. An article including at least one part or element made of a solid polymer composition according to claim 48.

63. The article according to claim 62, being a packaging, a container, a crate, a bin, a toy, a household item, gloves, curtain, a mask, a sticky surface, a coating material, a part of an appliance, an automotive part, a knob, a grip, a handle, a pipe, a tube, a sheet, a film, a bottle, a canister, a fiber, a woven and nonwoven textile, or a profile.

64. The article according to claim 62, wherein the composition or object is a film or a sheet.

65. The article according to claim 62, being a multicomponent article or a multilayered article.

66. A solid polymer composition or object comprising a polymeric material and at least one agent comprising DOPA and an antimicrobial functionality, wherein at least a portion of the antimicrobial functionalities is surface exposed to render surface antifouling and antimicrobial properties to said solid polymer composition or object, wherein the solid composition or object are free of surface-coated antimicrobial agents.

67. The solid polymer composition or object according to claim 66, comprising a polymeric material and at least one agent, wherein the at least one agent is selected from
-DOPA-Phe(4F)-Phe(4F)—OMe,
-DOPA-Phe-Phe(4F)—OMe,
-DOPA-Phe(4F)-Phe-OMe,
-DOPA-Phe-Phe-OMe,
-DOPA-Phe,
-DOPA-Phe(4F),
-DOPA-L-Phe(4F),
-DOPA-L-Phe,
-DOPA-L-Phe(4F)-Phe(4F)—OMe,
-DOPA-L-Phe-Phe(4F)—OMe,
-DOPA-L-Phe(4F)-Phe-OMe,
-DOPA-L-Phe-Phe-OMe,
wherein DOPA as is defined herein, Phe is phenylalanine and Phe(4F) is a phenyl alanine moiety substituted with an F atom at the 4 position of the phenyl ring, and wherein L is a linker moiety.
